(19) United States
(12) Patent Application Publication
(10) Pub. No.: US 2022/0026884 A1
(43) Pub. Date: Jan. 27, 2022

(54) AUTONOMOUS COORDINATION OF DEVICES IN INDUSTRIAL ENVIRONMENTS

(71) Applicant: Siemens Aktiengesellschaft, Munich (DE)

(72) Inventors: Gustavo Arturo Quiros Araya, Princeton, NJ (US); Jason Vandeventer, Charlotte, NC (US); Andras Varro, Lawrenceville, NJ (US); Richard Gary McDaniel, Hightstown, NJ (US)

(21) Appl. No.: 17/417,539

(22) PCT Filed: Jan. 25, 2019
(86) PCT No.: PCT/US2019/015111

§ 371 Date: Jun. 23, 2021

(51) Int. Cl. G05B 19/418; G06N 20/00; G06K 9/62

(52) U.S. Cl. CPC G05B 19/4185; G05B 19/41865; G06K 9/6256; G06N 20/00; G05B 19/4188

(57) ABSTRACT

Over the past several decades, rapid advances in semiconductors, automation, and control systems have resulted in the widespread adoption of advanced automated machines (including robots) in complex industrial environments. These machines are deployed in a very wide range of industrial settings and carry out an immense variety tasks in a limited and predefined manner. A systematic approach coordinates the actions of machines to allow a hierarchy of autonomous systems to make decisions about how to meet manufacturing demands, including delegation to lower-level autonomous systems.

### TECHNICAL FIELD

This disclosure relates to the coordinating operation of industrial machines. In particular, this disclosure relates to the coordination of actions among a hierarchy of machines in an industrial environment, such as a manufacturing environment.

### BACKGROUND

Over the past several decades, rapid advances in semiconductors, automation, and control systems have resulted in the widespread adoption of advanced automated machines such as robots in complex industrial environments. These machines are deployed in a very wide range of industrial environments and carry out an immense variety tasks in a limited and predefined manner. Improvements in machine intelligence and autonomy will further enhance the capabilities of these machines and lead to increased production, operation, and maintenance efficiencies.

### BRIEF DESCRIPTION OF THE DRAWINGS

FIG. 1 shows an example industrial environment with an autonomous hierarchical framework.

FIG. 2 shows an example of the autonomous hierarchical framework causing adaptation in the industrial environment.

FIG. 3 shows an example of setting up an autonomous hierarchical framework.

FIG. 4 shows an example of coordination logic that a coordination system may implement, and an example of worker logic that a worker system may implement.

FIG. 5 shows an example system implementation of a worker system and a coordination system in an autonomous hierarchical framework.

### DETAILED DESCRIPTION

The widespread adoption of advanced automated machines in complex industrial environments has resulted in many benefits. However, these machines carry out their tasks in a limited and predefined manner. That it, the machines execute actions that are predefined by the designers and programmers, and therefore lack flexibility and adaptability, e.g., to overcome new problems in the current environment or carry out functions in a new environment, without enormous effort, time, and money spent on manual reconfigurations. The autonomous coordination system and techniques described below overcome these and other technical challenges.

The autonomous coordination system and techniques provide a hierarchical framework in which systems and devices (as examples, PLCs, robots or other machines, and software agents) coordinate their actions, e.g., to manufacture products described by digital twins/CAD models. Within the hierarchical framework, higher-level autonomous systems (‘coordinators’) make decisions about how to proceed, e.g., how to manufacture an incoming order, and delegate actions to lower-level autonomous systems. The higher-level autonomous systems make adjustments based on available resources, materials, parts, time, and other factors. The coordinators and workers in the industrial environment use sensors (e.g., cameras, infrared detectors, ultrasonic sensors, and so on) to analyze real-world objects, compare them to the expected DT/CAD models, and make adjustments based on the differences. At any desired hierarchical level, the systems and devices train machine intelligence models and execute machine intelligence (e.g., statistical learning or deep neural networks) to learn about past experiences and train their models with these experiences to prepare for future decisions.

Underlying the autonomous coordination system and techniques are several technical solutions to the problems noted above. These technical solutions include hierarchical task decomposition and assignment, adjustment of actions, and machine learning. The technical solutions are implemented in a hierarchical framework that overcomes the technical problems of limited flexibility and adaptability of machines and systems in the industrial environment.

With regard to hierarchical task decomposition and assignment, the autonomous systems and devices within the framework form a hierarchy with different levels of autonomy in order to handle complex manufacturing tasks. In that regard, the tasks are decomposed into subtasks and assigned to more specialized autonomous systems. With regard to adjustment of actions based on physical objects and resources, the autonomous systems and devices, at any desired levels in the hierarchy, may adjust their actions in response to many different types of inputs. The adjustments may, as examples, adapt to physical variations of the materials and parts with respect to the original models, or adapt to the availability of resources.

Within the framework, machine learning is implemented at all desired levels. As a result, the autonomous systems at all levels support their decision-making with machine learning, thereby influencing their decisions based on past experiences. The specific type (or types) of machine learning applied in or to a given system may vary according to many factors, such as the role of the system (e.g., coordination system vs. specialized worker system) within the industrial environment. For instance, a coordination system may learn that a particular subordinate system is better suited for performing a particular action (e.g., faster or in a more reliable manner) than other subordinate systems, and in response may favor the particular subordinate system for selection in future task assignments. The entire framework thereby exhibits a form of heterogeneous distributed learning where individual autonomous systems learn in specific ways.

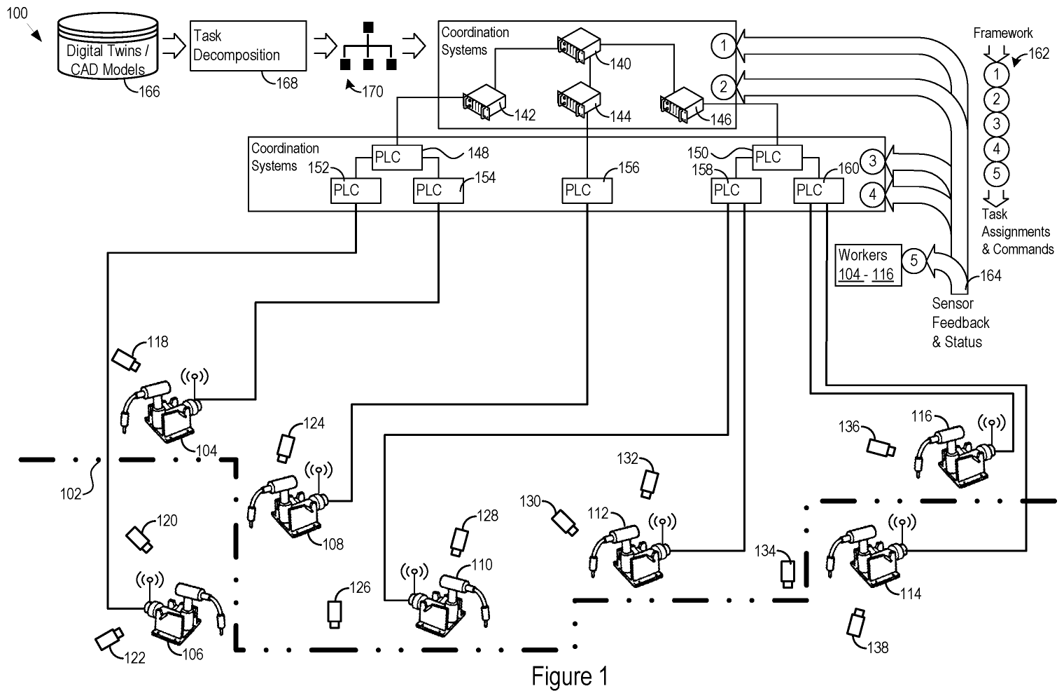

FIG. 1 shows an example industrial environment 100. The industrial environment 100 includes an assembly line 102 and multiple manufacturing devices positioned along the assembly line, e.g., the devices 104, 106, 108, 110, 112, 114, and 116. The automation environment 100 also includes sensors, e.g., the sensors 118, 120, 122, 124, 126, 128, 130, 132, 134, 136, and 138 that provide feedback from the environment 100. The manufacturing devices 104-116 may be any type of machine or system, including as just a few examples: robots, mixers, welders, belts, conveyors, lifts, injectors, lathes, milling machines, fixtures, planers, and the like. The devices 104-116 are worker systems that perform specific tasks, e.g., attaching, painting, or drilling in furtherance of creating, fabricating, or assembling a particular product. The sensors 118-138 may be any type of feedback device, including as just a few examples: cameras, microphones, current sensors, voltage sensors, rotation sensors, vibration sensors, rpm sensors, pressure sensors, touch sensors, proximity sensors, thermocouples, volume sensors, tilt sensors, temperature sensors, and the like.

FIG. 1 also shows coordination systems that determine and assign tasks to lower-level coordination systems or to worker systems. The coordination systems and worker systems are arranged in layers in a hierarchy. In the example of FIG. 1, the coordination system 140 is at the highest layer, layer 1, and the coordination system 142, 144, and 146 are at the second layer, layer 2. Further coordination systems are present: the coordination system 148 and 150 at layer 3, and the coordination systems 152, 154, 156, 158, and 160 at layer 4. The worker systems 104-116 are at the lowest layer, layer 5, and with the coordination systems 140-160 form an autonomous hierarchical network 162. Each layer receives feedback 164 from the industrial environment, e.g., from the sensors 118-138. There may be any number of coordination systems and worker systems of any purpose or complexity arranged in any number of levels in any given industrial environment.

The network 162 receives input from digital product models 166. The digital product models 166 may include, as examples, digital twins (“DT”) and computer aided design (“CAD”) models of the product to be manufactured, as well as its subcomponents and subassemblies. The digital twins and CAD models may also specify elements that exist within the industrial environment 100 itself, including the devices 104-116, sensors 118-138, assembly line 102, and coordination systems 140-160. In this way, the network 162 has knowledge concerning the configurations and capabilities of the products and the devices and systems that will create the products, and can execute machine learning and task planning based on that knowledge and other inputs.

Any product model may be input to a task decomposition system 168. The task decomposition system 168 analyzes the product model and generates a hierarchical task decomposition 170 for how to manufacture the product defined by the product model. The hierarchical task decomposition 170 is one of the inputs to the coordination systems 140-160. In particular, the top-level coordination system 140 may accept the hierarchical task decomposition 170 and initiate a process by which individual tasks are assigned throughout the network 162 in order to create the product defined in the product model.

Expressed another way, the framework 166 provides an autonomous technique for generating tasks based on the task decomposition 170 and automatically distributing tasks to devices and systems in the network 162 to perform the task. Starting with the digital product models 166, a manufacturing plan is created as a hierarchical decomposition of tasks. This decomposition may be produced beforehand by a task decomposition system 168, or it may be created by the autonomous systems themselves as part of their problem-solving functionality supported by machine learning.

For example, the level 1 coordination system 140 may receive the task decomposition 170, determine first level tasks to be executed, assign the first level tasks to specific devices in the next level, e.g., to the level 2 coordination systems 142-146, and issue commands to initiate task execution. The machine intelligence in the level 1 coordination systems 140 may make adjustments to any part of the manufacturing plan, e.g., based on resource availability, capacity, speed, reliability, or other characteristic of the devices and systems in the industrial environment 100, and also based on physical properties of the components and environments on which the worker systems execute their tasks. For instance, the level 1 coordination system 140 may reorder or replace tasks that are not achievable with substitute tasks that are currently achievable. In that regard, the machine intelligence may execute logistics and planning logic in an autonomous manner.

Task decomposition, planning, and changes may be repeated at all levels of the framework 166. For example, the level 2 coordination systems 142-146 may make adjustments to the tasks they have received and determine how best to distribute tasks to the level 3 coordination systems 148-160. Individual tasks will eventually reach the workers at the lowest level of the network 162. The worker systems are typically specialized for specific manufacturing tasks, with the higher-level coordination systems choosing worker systems based on the tasks that need to be carried out and on the production flow. The worker systems execute their tasks as specified while using the sensors 118-138 to analyze physical objects and their environment. The worker systems evaluate the sensor feedback 164, e.g., to compare the sensor feedback 164 to the digital product models 166. If a worker detects a significant difference, e.g., the size of a part is slightly larger than in the model, or the position of a hole for a screw is in a different position as specified, then the network 162 (either the worker itself or a higher-level entity) automatically makes adjustments based on these differences and evaluates the success of the operation.

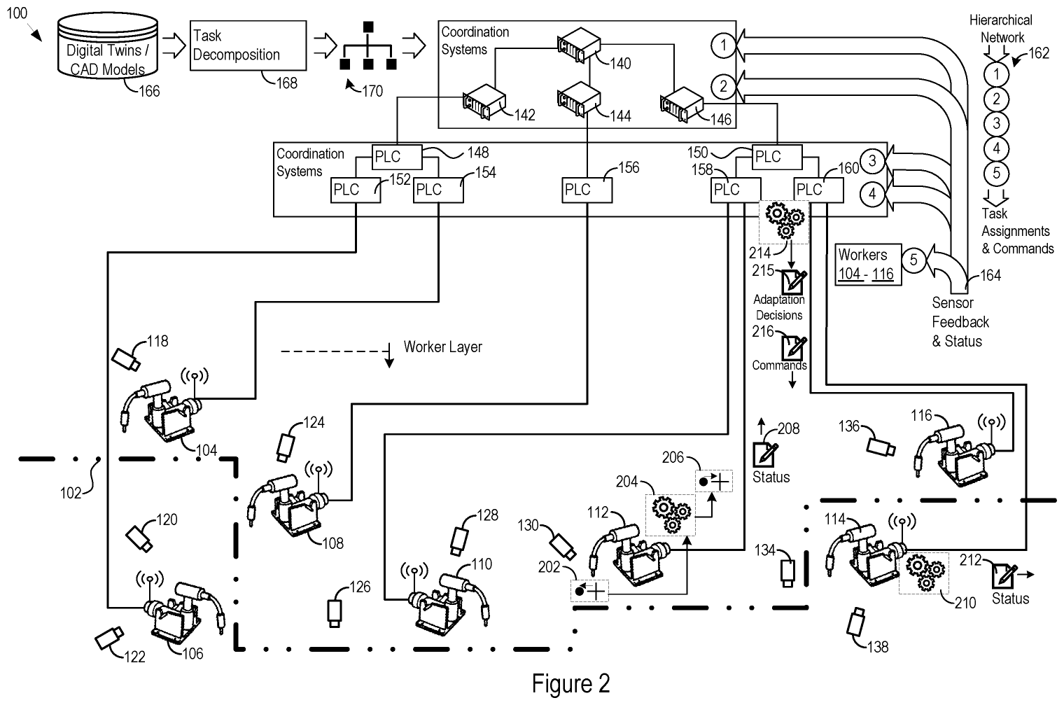

FIG. 2 shows a specific example of the autonomous hierarchical network 162 causing adaptation in the industrial environment 100. In this example, the worker system 112 has received sensor input 202 from the camera 130. The machine intelligence system 204 in the worker system 112 determines (e.g., by reviewing the image with an image processing neural network) that an actual screw hole position is 10 mm left of where the CAD model indicates.

As one option, the worker system 112 itself may determine how to move to account for the actual screw position. In this example, the machine intelligence system 204 makes an adaptation decision 206. The adaptation decision 206 is an adjustment to move 10 mm to the right to achieve proper alignment with the screw hole.

All of the devices and systems in the network 162 may provide status reports to devices and systems higher in the network 162. Accordingly, the higher level systems are informed of the overall progress and any problems with the manufacturing process, and may execute their machine intelligence to decide on possible adaptations if needed. In the example of FIG. 2, the machine intelligence system 204 in the worker system 112 sends a status report 208 to its immediate superior coordination system 158.

The status report 208 includes, e.g., the sensor input, findings from the machine intelligence system 204, and any adaptations performed or recommended. A status report may include any other desired information, including performance and accuracy data of the devices and systems, so that they may be assessed and confirmed at all levels. Data characterizing the ongoing operations, the sensor feedback 164, and adaptation decisions may be applied as training cases for refining any of the machine learning functions of the worker systems or coordination systems 140-160. Accordingly, future decisions at every level of the network 162 may be informed by past actions and the updates to the trained model.

Continuing the example in FIG. 2, the worker system 112 decided to move 10 mm to the right. However, assume that the new location causes an assembly error because the camera 130 was out of calibration. The worker system 112 may not itself be able to detect the error in the case it affects a subsequent manufacturing stage, e.g., a further assembly step at the worker system 114. However, the machine intelligence system in another device or system may detect the error and provide a status report to a higher-level system. In FIG. 2, the machine intelligence system 210 in the worker system 114 detects the error and provides the status report 212 to the coordination system 160.

The coordination system 160 may make a decision on how to proceed, e.g., by executing its machine intelligence system 214, or may refer the status to a higher level. In other words, a coordination system makes an adaptation decision 215, e.g., to make a specific adaptation in the production to respond to the error, or may take other actions. As a specific example, the coordination system 160 may issue production commands 216 to any system or device in the industrial environment 100, e.g., to discard the part and schedule the production of a replacement part with an alternate worker. Further, the coordination system 160 may train the machine learning model for its machine intelligence system 216 on the experience and report a suspected calibration issue to the responsible worker, e.g., the worker system 112, which may decide upon further adaptations to its behavior.

In the network 162, the systems and devices implement machine learning techniques that provide the systems and devices with a certain degree of autonomy. That is, the systems and devices make decisions on their own when possible, sensible, or allowed, and based on past experiences and acquired knowledge. Note that the hierarchical structure of the network 162 is not fixed but is determined on-demand for every incoming manufacturing order and may change dynamically during production of an order.

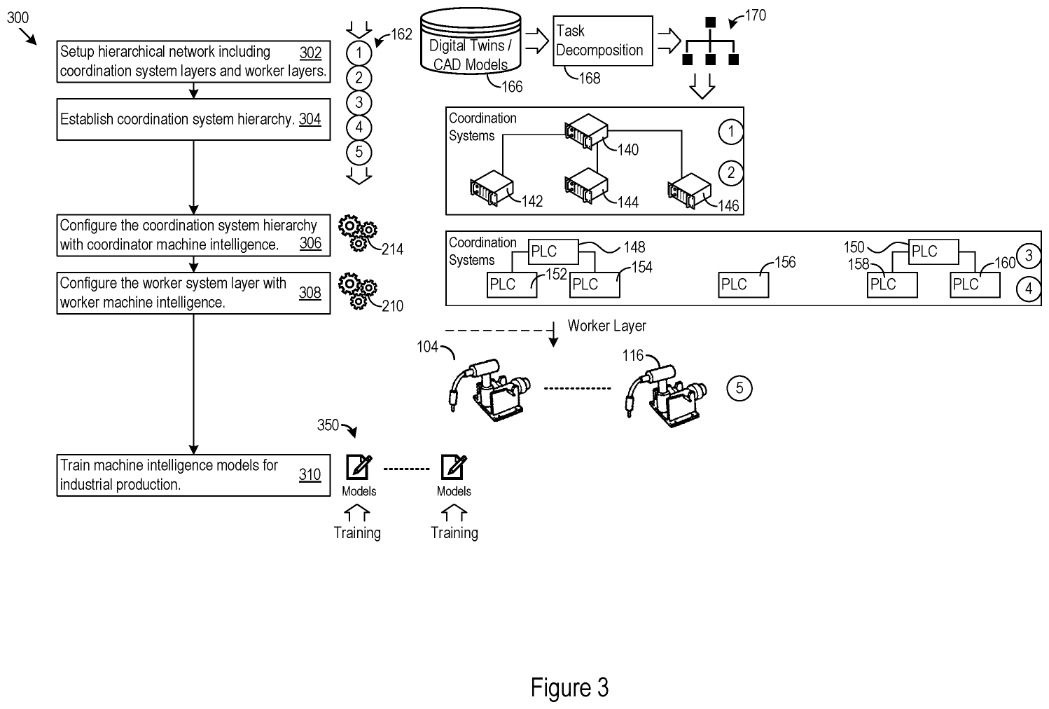

FIG. 3 shows an example of network setup logic 300 for an industrial environment. A hierarchical network is setup in the industrial environment 100, including one or more coordination system layers in communication with one or more worker system layers (302). A coordination system hierarchy is established in the coordination system layer (304). FIGS. 1 and 2 show, as an example, the hierarchy of coordination systems 140-160 arranged into four layers with coordination system 140 at the top layer of the hierarchy. Any given industrial environment may have any number of layers in the hierarchy with any number of coordination systems or worker systems in the layers.

The coordination system hierarchy is configured with coordinator machine intelligence (306). This may include configuring one or more coordination systems in any of the coordination system layers with machine intelligence circuitry and machine intelligence models. Alternatively or additionally, a set of coordination systems may share a common set of machine intelligence circuitry and machine intelligence models. In addition, worker systems in the worker system layer are configured with worker machine intelligence (308). This may include configuring one or more worker systems with machine intelligence circuitry and machine intelligence models 350. Alternatively or additionally, a set of worker systems may share a common set of machine intelligence circuitry and machine intelligence models. The machine intelligence models 350 are trained to prepare for industrial production (310). For instance, vision processing neural networks may be trained according to the expected role of each worker system. There are many types of machine intelligence circuitry and many types of machine intelligence model training that may be implemented. A few examples include: perception, reasoning, and problem solving; motion planning and manipulation; planning, learning, and natural language processing; statistical and symbolic learning; probabilistic techniques for uncertain reasoning; Bayesian reinforcement learning, neural fitted Q-Iteration (NFQ), and deep reinforcement learning.

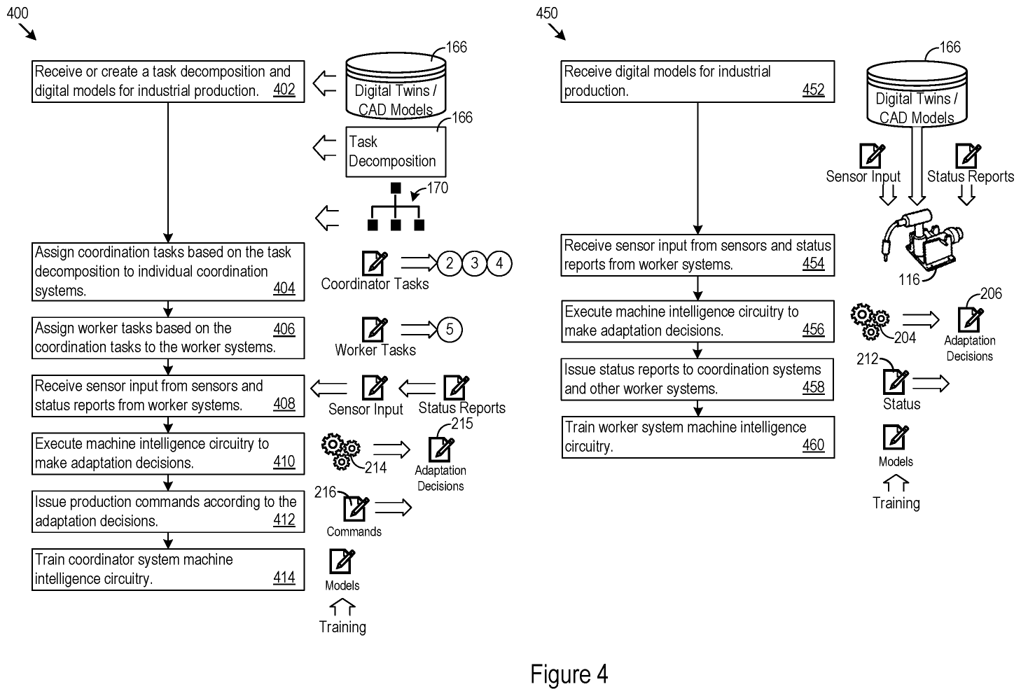

FIG. 4 shows an example of coordination logic 400 that a coordination system may implement, and an example of work logic 450 that a worker system may implement on an ongoing basis during industrial production. The coordination system layer receives digital product models and a task decomposition for industrial production (402). For instance, the coordination system 140 may receive the task decomposition and digital models from an external client, engineering system, or other source. The coordination system layer assigns coordinator tasks based on the task decomposition to individual coordination systems in the coordination system hierarchy (404). For instance, each of the coordination systems 142-146 may receive coordination tasks from the coordination system 140. In turn, the coordination systems 148-160 may receive coordination tasks from the coordination systems 142-146.

The coordination systems assign work tasks based on the coordination tasks to the worker systems (406). The coordination systems and worker systems receive sensor input from the industrial environment 100 and status reports from the worker systems (408). The coordination systems execute their machine intelligence circuitry in response to the sensor input, digital models 166, and status reports to make adaptation decisions 215 to the industrial production (410). The coordination system may also issue production commands 216 according to the adaptation decisions 215 (412). The coordination systems train their coordinator machine intelligence circuitry both responsive to the adaptation decisions 215 (414).

With regard to the worker systems, the worker systems may also receive the digital models 166 (452), either directly or from the coordination systems. The worker systems also receive the sensor input and the status reports from other worker system (454). The worker systems themselves may make adaptation decisions based on the sensor input, status reports, and digital product models 166 (456). The worker systems issue status reports to the coordination systems and other worker systems (458), e.g., to report adaptation decisions and reasons for the adaptation decisions. In addition, the worker systems may train their machine intelligence circuitry in response to any external inputs, including the sensor input, production commands, and status reports from other worker systems (460).

Expressed another way, a system control architecture in an industrial environment provides for autonomous coordination of devices in the industrial environment. The system includes a communication interface configured to receive a task decomposition and a digital product model for industrial production. Coordination system circuitry is in communication with the communication interface, and worker layer circuitry is in communication with the coordination system circuitry. The coordination system circuitry is configured to receive the task decomposition and transmit production tasks to the worker layer circuitry based on the task decomposition. The coordination system circuitry also receives status reports on the industrial production from the worker layer circuitry, and adapts a coordination system machine intelligence model in response to the status reports.

The worker layer circuitry is configured to receive the production tasks and execute the production tasks. While executing the production tasks, the worker layer circuitry analyzes the execution with a worker machine intelligence model and may transmit status reports to the coordination system circuitry responsive to analyzing the execution. The worker layer circuitry adapts execution of the production tasks based on the ongoing analysis performed by the worker machine intelligence and also responds to production commands received from the coordination system circuitry, e.g., those generated in response to the status reports.

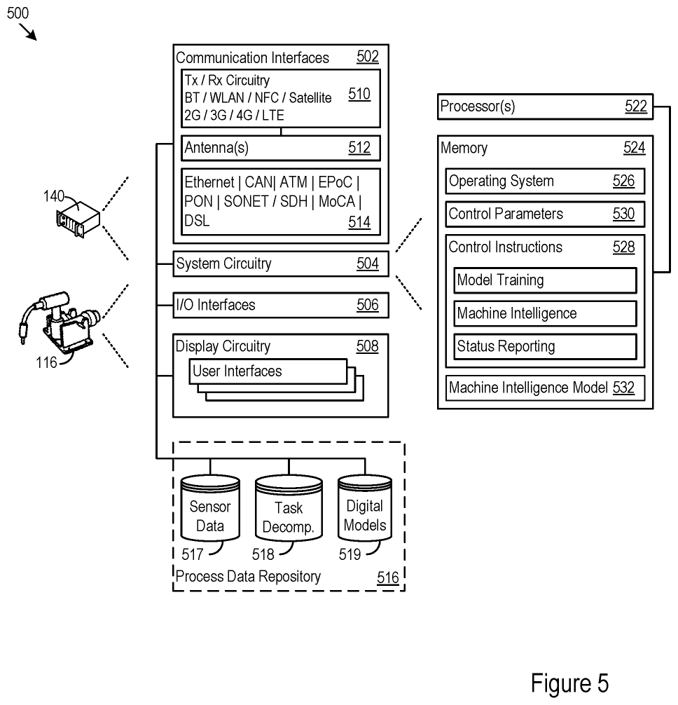

FIG. 5 shows an example system implementation 500 that a worker system or a coordination system may include to support the machine intelligence and automated coordination features described above. Each worker system and coordination system may vary widely in implementation and in additional features and capabilities.

The implementation 500 includes communication interfaces 502, system circuitry 504, input/output (I/O) interfaces 506, and display circuitry 508. The system circuitry 504 may include any combination of hardware, software, firmware, or other circuitry. The system circuitry 504 may be implemented, for example, with one or more systems on a chip (SoC), application specific integrated circuits (ASIC), microprocessors, microcontrollers, discrete analog and digital circuits, and other circuitry.

The system circuitry 504 is part of the implementation of any desired functionality in the coordination systems 140-160 and worker systems 104-116. That is, the system circuitry 504 may implement the techniques described above, e.g., with respect to FIGS. 1-4. The systems may store and retrieve data from a local or remote process data repository 516. For instance, the process data repository 516 may store sensor data 517, task decompositions 518, and digital models 519, status messages, or any other data.

The display circuitry 508 and the I/O interfaces 506 may include a graphical user interface, touch sensitive display, voice or facial recognition inputs, buttons, switches, speakers and other user interface elements. Additional examples of the I/O interfaces 506 include Industrial Ethernet, Controller Area Network (CAN) bus interfaces, Universal Serial Bus (USB), Serial Advanced Technology Attachment (SATA), and Peripheral Component Interconnect express (PCIe) interfaces and connectors, memory card slots, and other types of inputs. The I/O interfaces 506 may further include Universal Serial Bus (USB) interfaces, audio outputs, magnetic or optical media interfaces (e.g., a CDROM or DVD drive), network (e.g., Ethernet or cable (e.g., DOCSIS) interfaces), or other types of serial, parallel, or network data interfaces.

The communication interfaces 502 may include transceivers for wired or wireless communication. The transceivers may include modulation/demodulation circuitry, digital to analog converters (DACs), shaping tables, analog to digital converters (ADCs), filters, waveform shapers, filters, pre-amplifiers, power amplifiers and/or other circuitry for transmitting and receiving through a physical (e.g., wireline) medium such as coaxial cable, Ethernet cable, or a telephone line, or through one or more antennas. Accordingly, Radio Frequency (RF) transmit (Tx) and receive (Rx) circuitry 510 handles transmission and reception of signals through one or more antennas 512, e.g., to support Bluetooth (BT), Wireless LAN (WLAN), Near Field Communications (NFC), and 2G, 3G, and 4G/Long Term Evolution (LTE) communications.

Similarly, the non-wireless transceivers 514 may include electrical and optical networking transceivers. Examples of electrical networking transceivers include Profinet, Ethercat, OPC-UA, TSN, HART, and WirelessHART transceivers, although the transceivers may take other forms, such as coaxial cable network transceivers, e.g., a DOCSIS compliant transceiver, Ethernet, and Asynchronous Transfer Mode (ATM) transceivers. Examples of optical networking transceivers include Synchronous Optical Networking (SONET) and Synchronous Digital Hierarchy (SDH) transceivers, Passive Optical Network (PON) and Ethernet Passive Optical Network (EPON) transceivers, and EPON Protocol over Coax (EPoC) transceivers.

Note that the system circuitry 504 may include one or more controllers 522, e.g., microprocessors, microcontrollers, FGPAs, GPUs, Intel Movidius™ or ARM Trillium™ controllers, and memories 524. The controllers 522 may be dedicated general purpose or customized machine intelligence hardware accelerators, for instance. The memory 524 stores, for example, an operating system 526 and control instructions 528 that the controller 522 executes to carry out desired functionality for the coordination systems 140-160 or the worker systems 104-116. The control parameters 530 provide and specify configuration and operating options for the control instructions 528. Accordingly, the control instructions 528 may implement and execute machine intelligence (e.g., to make adaptation decisions), model training, status reporting, issuing production commands, and other features described above.

The methods, devices, processing, circuitry, and logic described above may be implemented in many different ways and in many different combinations of hardware and software. For example, all or parts of the implementations may be circuitry that includes an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when executed by the circuitry.

Various implementations have been specifically described. However, many other implementations are also possible.

What is claimed is:

1. A method for autonomous coordination of devices in an industrial environment, the method comprising:
establishing a hierarchical network in an industrial environment, the hierarchical network comprising a coordination system layer in communication with a worker layer;
establishing a coordination system hierarchy of coordinators in the coordination system layer;
configuring the coordination system hierarchy with coordinator machine intelligence circuitry;
in the worker layer, configuring worker systems with worker machine intelligence circuitry;
receiving a task decomposition for industrial production at the coordination system layer;
assigning coordinator tasks based on the task decomposition to individual coordinators in the coordination system hierarchy;
with the coordination systems, assigning worker tasks based on the coordinator tasks to the worker systems;
receiving sensor input from the industrial environment;
providing the sensor input to the coordination system layer and to the worker layer;
making an adaptation decision to the industrial production based on the sensor input; and
training the coordinator machine intelligence circuitry, the worker machine intelligence circuitry, or both responsive to the adaptation decision.

2. The method of claim 1, further comprising:
receiving a digital product model at the coordination system layer; and
providing the digital product model to the worker layer for use during the industrial production.

3. The method of claim 1, further comprising:
receiving a digital product model at the coordination system layer; and
where making an adaptation decision comprises:
making the adaptation decision based on the sensor input with respect to the digital product model.

4. The method of claim 3, further comprising:
providing the digital product model to the worker machine intelligence circuitry; and where:
making the adaptation decision comprises:
deciding on the adaptation decision with the worker machine intelligence circuitry, to adapt the industrial production.

5. The method of claim 4, further comprising:
training a machine intelligence model used by the worker machine intelligence circuitry on the adaptation decision.

6. The method of claim 5, further comprising:
transmitting a status report regarding the adaptation decision to the coordination system layer.

7. The method of claim 6, further comprising:
transmitting, from the coordination system layer, a production command in response to the adaptation decision and the status report.

8. The method of claim 3, where:
making the adaptation decision comprises:
deciding, with the coordinator machine intelligence circuitry, to adapt the industrial production.

9. The method of claim 8, further comprising:
training a machine intelligence model used by the coordinator machine intelligence circuitry on the adaptation decision.

10. A system for autonomous coordination of devices in an industrial environment, the system comprising:
in an industrial environment, a hierarchical network comprising a coordination system layer in communication with a worker layer;
a coordination system hierarchy in the coordination system layer, the coordination system hierarchy comprising coordinator machine intelligence circuitry;
worker systems in the worker layer, the worker layer configured with worker machine intelligence circuitry;
a communication interface configured to:
receive a task decomposition for industrial production at the coordination system layer;
receive sensor input from the industrial environment; and
provide the sensor input to the coordination system layer and to the worker layer;
where the coordination system hierarchy is configured to:
assign coordinator tasks based on the task decomposition to individual coordinators in the coordination system hierarchy; and
assign, to the worker systems, worker tasks based on the coordinator tasks; and
where the hierarchical network is configured to:
make an adaptation decision to the industrial production based on the sensor input; and
train the coordinator machine intelligence circuitry, the worker machine intelligence circuitry, or both responsive to the adaptation decision.

11. The system of claim 10, where:
the communication interface is further configured to:
receive a digital product model at the coordination system layer; and
provide the digital product model to the worker layer for use during the industrial production.

12. The system of claim 10, where:
the communication interface is further configured to:
receive a digital product model at the coordination system layer; and
where the hierarchical network is configured to:
make the adaptation decision based on the sensor input with respect to the digital product model.

13. The system of claim 12, where:
the communication interface is further configured to:
provide the digital product model to the worker machine intelligence circuitry; and where:
the worker layer is configured to:
decide on the adaptation decision with the worker machine intelligence circuitry, to adapt the industrial production.

14. The system of claim 13, where:
the worker layer is configured to:
train a machine intelligence model used by the worker machine intelligence circuitry on the adaptation decision.

15. The method of claim 14, where:
the worker layer is configured to:
transmit a status report regarding the adaptation decision to the coordination system layer.

16. The method of claim 15, where:
the coordination system layer is configured to:
transmit, from the coordination system layer, a production command in response to the adaptation decision and the status report.

17. The method of claim 12, where:
the coordinator machine intelligence circuitry is configured to make the adaptation decision comprises to adapt the industrial production.

18. The method of claim 17, where:
the coordination system layer is configured to:
train a machine intelligence model used by the coordinator machine intelligence circuitry on the adaptation decision.

19. A system for autonomous coordination of devices in an industrial environment, the system comprising:
a communication interface configured to receive a task decomposition and a digital product model for industrial production;
coordination system circuitry in communication with the communication interface;
worker layer circuitry in communication with the coordination system circuitry;
where the coordination system circuitry is configured to:
receive the task decomposition;
transmit production tasks to the worker layer circuitry based on the task decomposition;
receive status reports on the industrial production from the worker layer circuitry; and
adapt a coordinator machine intelligence model responsive to the status reports; and
where the worker layer circuitry is configured to:
receive the production tasks;
while executing the production tasks, analyze execution with a worker machine intelligence model; and
transmit the status reports to the coordination system circuitry responsive to analyzing the execution.

20. The system of claim 19, where:
where the worker layer circuitry is further configured to:
adapt execution of the production tasks responsive to analyzing execution with the worker machine intelligence model; and
respond to production commands received from the coordination system circuitry.
